(19) United States
(12) Patent Application Publication
(10) Pub. No.: US 2005/0025312 A1
(43) Pub. Date: Feb. 3, 2005

(54) Distribution of encrypted information

(76) Inventors: Albert Maria Arnold Rijkaert, Eindhoven (NL); Bartolomeus Johannes Van Rijnsoever, Eindhoven (NL)

Correspondence Address: Corporate Patent Counsel;Philips Electronics North America Corporation, PO Box 3001, Briarcliff Manor, NY, 10510, US

(21) Appl. No.: 10/501,166

(22) PCT Filed: Dec. 9, 2002
(86) PCT No.: PCT/IB02/05272

(30) Foreign Application Priority Data
Jan. 14, 2002 (EP) 02075144.2

(51) Int. Cl. H04K 1/06

(52) U.S. Cl. 380/37

(57) ABSTRACT

A secure device capable of selectively enabling decryption of units of information is used to provide access to a stream of units of encrypted information. Each unit is linked to a time-stamp. An entitlement management message entitles the secure device to enable decryption of units of information that are linked to time-stamps with values in a specified range. The range has a starting point substantially prior to a current time value of the time stamps distributed concurrent the entitlement message. In an embodiment the stream is distributed to a plurality of subscribers, each with an own secure device. The distance of the starting point to the current time value for each subscriber is selected dependent on subscription information for the subscriber.

The invention relates to a method of distributing encrypted information and providing conditional access to that information, to a system for distributing encrypted information and to a secure device for use in such a system.

From PCT patent application WO98/27732 a conditional access system is known that uses time-stamps to control a time-interval in which a secure device is enabled to decrypt information. The system broadcasts a data stream that contains encrypted information and entitlement control messages (ECM's). The decryption key needed to decrypt the information changes with time. Each time when a new decryption key is needed, this key is broadcast in an ECM. The decryption key itself has to be decrypted from the ECM. This is done in a smart card (or more generally with a secure device), which contains the necessary decryption key for decrypting keys from the ECM's. The smart card supplies the decrypted keys to decoding device, which decrypts the information from the data stream.

Such a conditional access system is conventionally used under circumstances where subscribers pay for the right to access information. The main example of this is a video signal distribution system such as a cable TV system where subscribers pay for the right to view certain channels. The smart cards of the subscribers that have paid are enabled to supply decrypted keys to the decoding device. To control conditional access the smart card contains entitlement information, which specifies the circumstances under which the smart card should decrypt the keys and supply them to the decoding device. The entitlement information is supplied to the smart card in entitlement management messages (EMM's) with the data stream.

One important requirement of conditional access systems is that they should be resistant to tampering to gain unauthorized access. For example, decryption of the information is normally limited to a time period for which a subscription fee has been paid. One form of tampering is the so-called replay attack, in which part of the data stream is stored in a medium for some time and supplied to the smart card and the decoding device with a delay. Thus, a part of the data stream might be decoded that is received outside the period in which the smart card is entitled to supply keys to the decoding device.

The system of WO98/27732 describes a mechanism is to counter such tampering. A the beginning of the subscription period the system sends an EMM that specifies the start and end of the subscription period, that is, the time period in which the smart card should supply the keys and, conversely, outside which the smart card should not supply the keys to the decoding device. Time stamps are added to the ECM's. The time-stamps identify the time at which each ECM has been broadcast. When an ECM is received, the smart card tests whether its time-stamp is in the subscription period specified by the EMM and supplies the decrypted keys only if that is the case. Thus, recorded information that has been received outside the subscription period but is supplied to the secure device during the subscription period cannot be decrypted. Only information broadcast after the EMM, during the subscription period can be decrypted.

Amongst others, it is an object of the invention to provide other kinds of selective access or more varied types of selective access to subscribers of an information distribution system with conditional access.

The method according to the invention is set forth in Claim 1. According to the invention a type of subscription is enable in which subscribers can subscribe to the opportunity to view stored information which has been broadcast in the past.

According to the invention the entitlement management message specifies a range of time values for which decryption of parts of the data stream is enabled. The range extends substantially into the past from the current time (substantially meaning sufficiently far into the past to contain for example at least a television program or a meaningful part of such a program, say at least one or more hours, days or weeks) and allows decryption of information that has been stored after distribution, so that the time stamps linked to the information do not substantially correspond to the current time (even allowing for transmission delays). As used herein the current time may include the date and time of day. The current corresponds to the time values of time stamps linked to the information units when the information units are distributed.

As a result the entitlement management message enables decryption of parts of the data stream that have been transmitted in that time period prior. That is, a secure device is enabled to supply decryption keys for stored information that has been received not more than the specified period before the current date and time. Thus, the subscriber is enabled to view time-shifted information, but only if the time shift is not too large.

This allows the service provider to sell services with different service levels, having a longer or shorter sliding window. For example, in one embodiment individual subscribers might opt for different service levels with time ranges that extend increasingly longer into the past, at increasingly higher subscription fees. Or conversely, for example for sports games, the subscription fee might be lower as the sliding window ends further back in the past. As a result a single broadcast of the game could be stored by different users that are allowed to view the game with different delays, according to their subscription. Thus, there is no need to rebroadcast the game for each group of users. The entitlement may extend to all information broadcast during the time range, or, alternatively, different entitlements to different ranges may be sent for different parts of the stream (for example for different television programs), or entitlements in the past may be sent only for some parts of the stream.

In a further embodiment, the time range slides with the current time, i.e. the start of the time range is kept at a predetermined distance before the current time and advances with the current time. This can be realized for example by regularly sending updates to the secure device to update the range, or by maintaining an advancing current time value in the secure device and testing the values of the time stamps relative to that current time value.

Preferably, the sliding window is also associated with some absolute time, so as to define a maximum time value to which the window can slide. This can be realized for example by including such a maximum time value in the entitlement management message that entitles the secure device to enable decryption in the sliding window. In this case, the secure device not only compares the time stamp from the data stream with the bounds of the window, but also with the maximum time value, and/or it compares the maximum time value with current date and time, before enabling decryption. In another example, this can be realized by linking renewal of other entitlement information (for example entitlement to view information during a coming subscription period) to an instruction to invalidate the sliding window if the subscriber has not paid for the sliding window.

In another embodiment the invention allows a subscription in which a subscriber can retroactively buy the right to decrypt information received during a fixed period (not sliding along with current time) ending at a time substantially prior to buying that right. In response to such an addition to the subscription an additional entitlement management message is sent to enable the subscriber to view information from parts of the data stream that he or she has stored in a medium in the fixed period. The period that starts and preferably also ends at predetermined times in the past.

Thus for example, after a holiday the subscriber can buy the right to view any content such as a television program or movie that has been broadcast during the holiday. The program need not be rebroadcast when the subscriber buys such an entitlement, since the entitlement enables the subscriber to use stored information.

These and other objects and advantageous aspects of the method and system according to the invention will be described in more detail using the following figures.

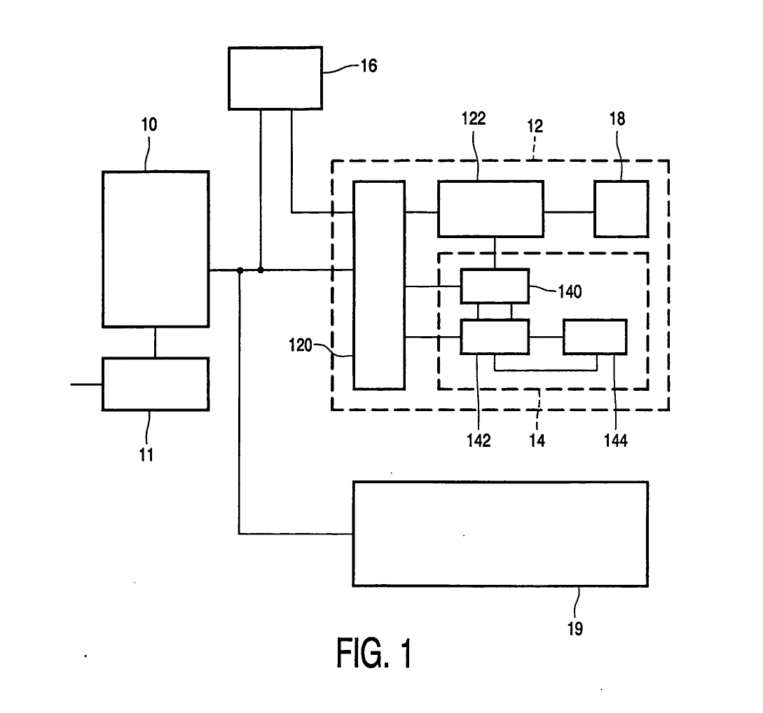

FIG. 1 shows an information distribution system

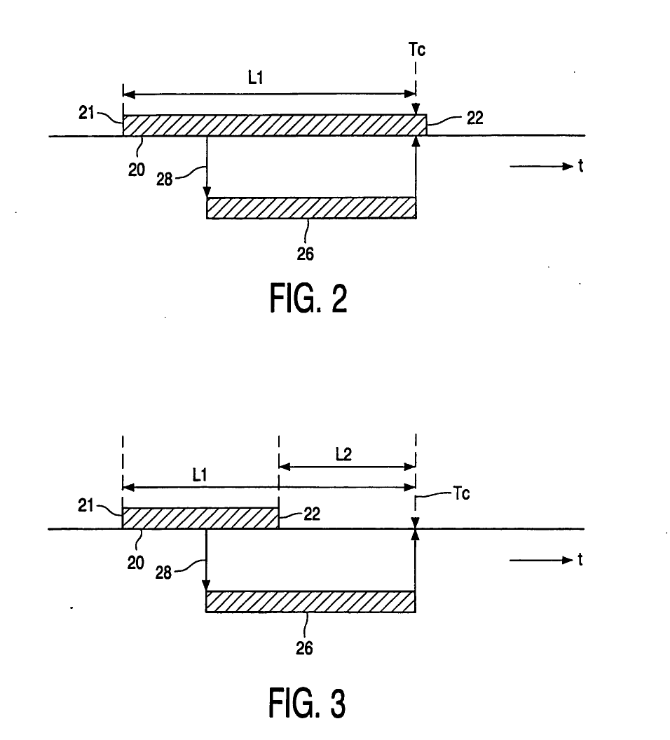

FIG. 2 shows an entitlement time-range

FIG. 3 shows a further entitlement time range.

FIG. 1 shows an information distribution system. The system contains a source 10 of an encrypted media stream, a subscription management unit 11, a conditional access apparatus 12, a storage device 16 (for example a magnetic or optical disk or a tape recorder) and a further receiving system 19. The subscription management unit 11 has an output coupled to the source 10. The source 10 has an output coupled to the conditional access apparatus 12, the storage device 16 and the further receiving system. The storage device 16 has an output coupled to the conditional access apparatus 12. Further receiving system 19 may contain any number of structures similar to the combination of conditional access apparatus 12 and storage device.

The conditional access apparatus 12 contains a receiving section 120, a content decoder 122, a rendering device 18 and a secure device 14 (for example a smart card). The receiving section 120 receives inputs from the source 10 and the storage device 16 and has an output for encrypted content coupled to the content decoder 122, and outputs for encryption control messages (ECM's) and encryption management messages (EMM's) coupled to secure device 14 (although shown separately, the latter outputs may in fact be combined into a single output). The secure device 14 has an output coupled to a key input of decoder 122. Decoder 122 has an output for decrypted content coupled to rendering device 18.

Secure device 14 contains a decryption unit 140, a management unit 142 and optionally time value storage 144. Decryption unit 140 has an input coupled to the output for ECM's of the receiving section and an output coupled to the key input of decoder 122. Decryption unit 140 also has an output for time stamps coupled to management unit 142. Management unit 142 has an input coupled to the output for EMM's of the receiving section 120. Furthermore management unit 142 has inputs and outputs coupled to optional time value storage 144. Separate inputs are shown for EMM's and ECM's but of course these may be supplied via a single input and processed separately in the secure device 14.

In operation, source 10 transmits one or more streams of encrypted media information (for example video and/or audio information). Each stream contains encrypted content, encryption control messages (ECM's) and encryption management messages (EMM's). The bandwidth requirements for these items differs widely: the content may require a permanent bandwidth of several megabits per second, whereas ECM's may require less than a kilobit and are transmitted, say, only once every minute. EMM's are transmitted even less frequently, say, once per hour. The encryption control messages contain keys for decrypting the encrypted content. These keys themselves are also encrypted. The encryption control messages preferably also contain time stamps. These time stamps may be encrypted, but this is not necessary. It suffices that they are authorized, i.e. encoded in such a way that it can be verified that reasonably only the source could have supplied the time-stamps and that an ECM is associated with a specific time stamp.

Conditional access apparatus 12 receives at least one of the streams. Receiving section 120 passes encrypted content from this stream to decoder 122. Receiving section 120 passes ECM's and EMM's from the stream to secured device 14. Secure device 14 decrypts keys from the ECM's and conditionally supplies them to decoder 122. With the keys, decoder 122 decrypts the content and supplies the decrypted content to rendering device 18, which contains for example a display screen and or a loudspeaker and which renders the content so that the content can be perceived by the user of the system.

Optionally time value storage 144 maintains a time value indicative of the date and the time of day. The time value in time value storage 144 is regularly updated. This may be done by a clock circuit (not shown) in secure device 14 or by management unit 142, for example each time when an ECM is received (or each time a predetermined number of ECM's has been received).

Any number of conditional access apparatuses such as conditional access apparatus 12, as contained in further receiving system 19 may receive the streams.

Source 10 transmits EMM's to secure device 14 to specify which keys secure device may supply to the decoder and when. In principle, each of the EMM's is directed at only one secure device 14, for example by including an identifier in the EMM that is unique to the secure device 14 and arranging the secure device to process only EMM's that have the identifier corresponding to the secure device 14. The EMM's are distinguished from the ECM's in that they are transmitted less frequently (because they do not need to supply keys for the encrypted content) and in that they contain management information, for example to set the type and times content for which the secure device 14 is entitled to supply keys. Thus, the EMM's are essential for controlling the conditions of access, but not directly for providing access.

Secure device 14 checks whether it is entitled to supply the keys to decoder 122. At least for some of the keys entitlement depends on time. To enforce this management unit 142 can make use of entitlement information received from source 10. In a simple form of time dependent entitlement for example, management unit 142 compares the time value from time stamp with a range of time-values specified in an EMM. Thus, for example, keys may be supplied only in periods for which the user has paid.

FIG. 2 shows an entitlement time range according to the invention. Date and time of day (jointly referred to as “time of day” or “t”) are plotted horizontally. An arrow indicates current time of day Tc, i.e. the time value of the time stamp broadcast at the time by source 10. A range 20 of time values with a start time 21 and an end time 22 is shown for which the secure device 14 is entitled to supply keys.

FIG. 3 shows a similar entitlement range, wherein the time-range ends before the current time of day Tc.

By way of illustration FIG. 2 also shows a storage time interval 26, starting from a storage time 28 and lasting until the current time of day Tc. When information received from source 10 is stored in storage device 16 at storage time 28 and replayed to secure device 14 at the current time of day Tc the time stamps from ECM's in the replayed information correspond to storage time 28 not to current time of day Tc. Management unit 24 will enable decryption unit 140 to supply the key from the ECM to decoder 122 nevertheless, as long as the time stamp corresponds to a time value within the time interval relative to Tc specified by T1, T2.

Source 10 specifies the range 20 by sending secure device 14 an EMM with a code indicating that an entitlement time-range 20 extending into the past is to be used. In response, management unit 142 stores information from this EMM (for example in the form of specific start and end times, or indirectly for example in terms of a starting point and a duration of the time range 20, or just a starting point, or with codes referring to predetermined durations and/or lengths stored in management unit 142). Subsequently, when management unit 142 receives a time-stamp from an ECM, management unit 142 compares this time stamp with specified range. If the time stamp is in the range management unit 142 enables decryption unit 140 to supply the decrypted key to decoder 122.

In an embodiment the range may be defined relative to the current time of day Tc maintained in time value storage 144. In this case the range lasts from a start point 21 at a time Tc-L1 preceding the current time of day Tc by the length L1 (for example a day) of a first time interval to an end time 22 at a time Tc-L2, preceding or following the current time of day Tc by the length of a second time of day (in the example of FIG. 2 L2 is slightly greater than zero). In this case management unit 142 computes for example whether the difference between the time stamp and the current time of day is between L1 and L2, to determine whether the time stamp is within the specified range relative to the current time of day Tc. If so management unit 142 enables decryption unit 140 to supply the decrypted key to decoder 122.

Thus a sliding window for time stamps is realized for which decryption is enabled. Alternatively such a sliding window may be realized by regularly transmitting new EMM's to update a fixed window in secure device 14 as time progresses during a single subscription.

Subscription management unit 11 selects the time range specified by the EMM's dependent on reception of information about payment of a subscription fee for a particular type of time interval. Subscription management unit 11 is implemented for example as a suitably programmed conventional computer, with a database of subscriber information that is updated by means of payment information and subsequently consulted to control the content of EMM's. When subscription management unit 11 has received information that a subscriber has paid a fee for a time-range that extends a certain length L1 into the past, subscription management unit 11 causes source 10 to transmit an EMM entitling the secure device 14 of that subscriber to supply keys to decoder 122 for decoding information that has been stored for some time. Both the length of the time range and its extent into the past may depend on the fee paid.

Subscription management unit 11 manages subscription information for a plurality of subscribers. The extent into the past of the range of time values for which decryption can be enabled can be set individually for different subscribers, dependent on the type of subscription to which each subscriber is entitled. Thus, EMM's that are directed at different subscribers (for example by specifying different ID)'s in the EMM's, so that each EMM will be processed only by the secure device corresponding to the ID), may specify different extents into the past, dependent on the subscription.

In a further embodiment, the time range 20 can be selected to start and end at predetermined start and end times 21, 22 independent of the current time of day Tc. When subscription management unit 11 receives a signal indicating that a subscriber has paid for such an entitlement it sends an EMM to this effect to the secure device 14 of the relevant subscriber.

Thus a subscriber that wants to view past information stored in storage device 16 for which the subscriber has no entitlement, could receive an EMM specifying that the subscriber is entitled to view the stored information on the basis of the time at which the information was transmitted (i.e. the time stamps in the ECM's associated with the information). This should be contrasted with entitling the subscriber to decrypt a certain piece of information by specifically identifying that information in the EMM. Thus, for example a TV subscriber that has been on holiday for some time could be given the right to view TV programs from the holiday period, without having to specify individual programs.

It will be understood that the invention applies to any system that distributes a stream of information units and provides access on a time dependent basis. For example, the invention is not limited to a system that transmits encrypted information and entitlement messages over the same connection as shown in FIG. 1. Similarly, the mechanism using ECM's and EMM's is show only by way of example: other ways of providing decryption keys may be used.

1. A method of distributing units of encrypted information and providing conditional access to the units, using a secure device (14) capable of selectively enabling decryption of said units, the method comprising
distributing a stream comprising the units of information successively, each linked to a respective time-stamp;
sending an entitlement management message to the secure device (14), the entitlement message including a specification of a range (21, 22) of time-stamp values and entitling the secure device (14) to enable decryption of units of information that are linked to time-stamps with values in that range (21, 22), wherein the range (21, 22) has a starting point (21) substantially prior to a time value (24) of the time stamps distributed concurrent the entitlement message.

2. A method according to claim 1, wherein the stream is distributed to a plurality of subscribers, each with an own secure device (14) and wherein the entitlement management message is one of a plurality of respective entitlement management messages, each sent receivable for the secure device (14) of a respective one of the subscribers, each entitlement management message including a specification of a respective range of time-stamp values (21, 22), the method comprising
receiving subscriber dependent subscription information;
setting a distance of said starting point (21) to said time value in each of the respective ranges (21, 22) according to a respective distance value and selecting each respective distance value from a set of two or more distance values, dependent on the subscription information for the subscriber for whose secure device (14) the entitlement management message is receivable.

3. A method according to claim 1, wherein the entitlement management message is one of a series of successive ones entitlement management messages, each specifying its own range (21, 22) so that said range slides with time so that the starting point substantially has a time independent distance to said time value (24).

4. A method according to claim 1, wherein the secure device (14) maintains and updates a current time value corresponding to the time values of the time stamps as they are distributed as a function of time, the secure device (14) adjusting said starting point to a time independent distance before the current time value, the secure device (14) deriving the time independent distance from said one of the entitlement management unit (24) at least for a series of successive current time values.

5. A method according to claim 1, wherein the range (21, 22) ends substantially before the time value of the time stamps distributed concurrent with said one of the entitlement messages.

6. A method according to claim 2, the subscription information comprising, for one of the subscribers, a selection of a further range (30, 32) ending substantially prior to the time value (24) of the time stamps distributed at a time of receiving said selection, the method comprising sending a further entitlement management message in addition to said entitlement messages, the further entitlement management specifying the further range (30, 32) and entitling the secure device (14) to enable decryption of units of information that are linked to time-stamps with values in that further range (30, 32).

7. An information distribution system that provides conditional access to units of encrypted information, the system comprising
an information distribution device (10) arranged to distribute a stream of successive units of encrypted information, each linked to a respective time-stamp
at least one information receiving device (12, 19) arranged to receive the stream
a secure device (14) coupled to the at least one information receiving device (12, 19), for selectively enabling decryption of the units under control of an entitlement management message including a specification of a range (21, 22) of time-stamp values and entitling the secure device (14) to enable decryption of units of information that are linked to time-stamps with values in that range (21, 22);
the information distribution device (10) being arranged to send the entitlement message so that the range (21, 22) has a starting point substantially prior to a time value (24) of the time stamps distributed concurrent with the entitlement message.

8. A system according to claim 7, the system comprising a plurality of secure devices (14, in 19), each for a respective subscriber, wherein the entitlement management message is one of a plurality of respective entitlement management messages, each sent receivable for a respective one of the secure devices (14, in 19), each of the entitlement management messages including a specification of a respective range of time-stamp values (21, 22), and wherein the information distribution device (10) has
an input for receiving subscriber dependent subscription information;
means (11) for setting a distance of said starting point to said time value in each of the respective ranges according to a respective distance value, the means (11) selecting each respective distance value from a set of two or more distance values, dependent on the subscription information for the subscriber for whose secure device the entitlement management message is receivable.

9. A secure device (12) for use in an information distribution system that provides conditional access to a stream of information units linked to time stamps, the secure device comprising
an input for receiving entitlement management messages;
a memory (144) for maintaining a current time count;
a management unit (142) for selectively enabling decryption of the information units under control of the entitlement management messages, the management unit (142) being arranged to implement one of the entitlement management messages that includes a specification of a range of time-stamp values linked to units of information, for which the secure device (14) has to enable decryption, wherein the extending substantially prior to the current time count.

10. An information distribution device (10, 11) arranged to distribute a stream of successive units of encrypted information to a secure device (14), each unit linked to a respective time-stamp, the device having
a transmitting unit (10) for transmitting an entitlement management message including a specification of a range (21, 22) of time-stamp values and entitling the secure device (14) to enable decryption of units of information that are linked to time-stamps with values in that range (21, 22) so that the range has a starting point (21) substantially prior to a time value (24) of the time stamps distributed concurrent with the entitlement message.

11. An information distribution device according to claim 10, arranged to distribute the stream to a plurality of subscribers, each having a respective secure device, the entitlement management message being one of a plurality of entitlement management messages for reception by respective ones of the secure devices, each entitlement management message specifying a respective range of time-stamp values, the device having
an input for receiving subscriber dependent subscription information;
means (11) for setting a distance of said starting point to said time value in each of the respective ranges according to a respective distance value, the means (11) selecting each respective distance value from a set of two or more distance values, dependent on the subscription information for the subscriber for whose secure device (14) the entitlement management message is receivable.
